(19) United States
(12) Patent Application Publication
(10) Pub. No.: US 2021/0157933 A1
(43) Pub. Date: May 27, 2021

(54) MONITORING PHYSICAL ARTIFACTS WITHIN A SHARED WORKSPACE

(71) Applicant: International Business Machines Corporation, Armonk, NY (US)

(72) Inventors: Mark Turano, Clifton, NJ (US); Zachary A. Silverstein, Jacksonville, FL (US); Robert Huntington Grant, Marietta, GA (US); Thomas Jefferson Sandridge, Tampa, FL (US)

(21) Appl. No.: 16/693,327

(22) Filed: Nov. 24, 2019

(51) Int. Cl. G06F 21/60; G06F 21/62; H04L 29/06; G06N 20/00

(52) U.S. Cl. CPC G06F 21/604; G06N 20/00; H04L 63/105; G06F 21/6218

(57) ABSTRACT

An approach for securing a shared physical workspace from leaking sensitive subject matter is disclosed. The approach leverages machine learning and gathers data associated with a meeting scheduled for a shared physical workspace along with the users. The approach captures the content of the meeting in the shared workspace and determines one or more risk score based on the captured content and determines whether the one or more users are authorized to be exposed to the captured content based on the one or more risk score. The approach can generate one or more plans to mitigate the risk of sensitive information being exposed.

### BACKGROUND

The present invention relates generally to the field of privacy within a shared workspace, and more particularly to securing physical artifacts in a shared workspace.

Office sharing and/or agile workspace environment is an arrangement in which several workers share an office space, allowing cost savings and convenience. For example, the backbone of agile workspace is an open floor plan. Within the open floor plans, several tables/desks exist in rows without divider walls where workers can select a spot to work (i.e., there are no assign seats/cubes). Furthermore, if a worker needs privacy or needs to collaborate in private with other members on the team, there are enclosed small rooms with doors.

Reputational risk is the potential loss to financial capital, social capital and/or market share resulting from damages to a firm's reputation. The cost of accidental data breach (e.g., electronic/soft copy, hard copy, etc.) for companies reaches thousands of dollars a year per incident, and even more in reputation risk and damage. Thus, when working in shared workspaces such as on client-site, the risk of accidentally sharing confidential competitor and internal data is heightened.

### SUMMARY

Aspects of the present invention disclose a method, computer program product, and system for securing a shared physical workspace from leaking sensitive subject matter The method includes gathering, by machine learning, data associated with a meeting scheduled for a shared physical workspace; detecting one or more users entering the shared physical workspace for the schedule meeting; capturing, by machine learning, content of the meeting in the shared workspace; assigning, by machine learning, one or more risk score based on the captured content; determining whether the one or more users are authorized to be exposed to the captured content based on the one or more risk score; responsive to determining that the one or more users are not authorized, generating and executing a first action plan; determining, by machine learning, whether the captured content exceed one or more risk threshold; and responsive to determining that the captured content exceeds the one or more risk threshold, generating and executing a second action plan, by machine learning.

In another embodiment, the computer program product includes one or more computer readable storage media and program instructions stored on the one or more computer readable storage media, the program instructions comprising: program instructions to gather, by machine learning, data associated with a meeting scheduled for a shared physical workspace; program instructions to detect one or more users entering the shared physical workspace for the schedule meeting; program instructions to capture, by machine learning, content of the meeting in the shared workspace; program instructions to assign, by machine learning, one or more risk score based on the captured content; program instructions to determine whether the one or more users are authorized to be exposed to the captured content based on the one or more risk score; responsive to determine that the one or more users are not authorized, program instructions to generate and executing a first action plan; program instructions to determine, by machine learning, whether the captured content exceed one or more risk threshold; and responsive to determine that the captured content exceeds the one or more risk threshold, program instructions to generate and executing a second action plan, by machine learning.

In yet another embodiment, the computer system includes one or more computer processors; one or more computer readable storage media; program instructions stored on the one or more computer readable storage media for execution by at least one of the one or more computer processors, the program instructions comprising: program instructions to gather, by machine learning, data associated with a meeting scheduled for a shared physical workspace; program instructions to detect one or more users entering the shared physical workspace for the schedule meeting; program instructions to capture, by machine learning, content of the meeting in the shared workspace; program instructions to assign, by machine learning, one or more risk score based on the captured content; program instructions to determine whether the one or more users are authorized to be exposed to the captured content based on the one or more risk score; responsive to determine that the one or more users are not authorized, program instructions to generate and executing a first action plan; program instructions to determine, by machine learning, whether the captured content exceed one or more risk threshold; and responsive to determine that the captured content exceeds the one or more risk threshold, program instructions to generate and executing a second action plan, by machine learning.

### BRIEF DESCRIPTION OF THE DRAWINGS

FIG. 1 is a functional block diagram illustrating a topology of a security environment, designated as 100, in accordance with an embodiment of the present invention;

FIG. 2 is a functional block diagram illustrating security component in accordance with an embodiment of the present invention;

FIG. 3 is a flowchart illustrating the operation of a security management system, designated as 300, in accordance with an embodiment of the present invention; and

FIG. 4 depicts a block diagram, designated as 400, of components of a server computer capable of executing the security management system within the security environment, of FIG. 1, in accordance with an embodiment of the present invention.

### DETAILED DESCRIPTION

Embodiments of the present invention provides the ability to manage and alert users to retrieve physical artifacts belonging to the user after the user has finished using a shared workspace. With the growing presence of shared workspaces, the risk of private information for a specific team leaking is increased. Other people may see remnants of these artifacts that expose potential sensitive subject matter such as dollar values and strategic decisions. For example, Mark is in a shared workspace that his organization is using to become more agile. Mark starts discussing employees raises for the quarter. This subject matter is sensitive and shouldn't be shared with other parties not privy to the meeting. This subject matter has been historically processed and contextually processed (e.g., Historical—Previous emails that say “sensitive” related to the content presented and Contextual—User says “Don't share this with anyone . . . ”). Based on strength of association between content mentioned in shared space, physical interactions that may leave traces, and threshold of risk, ameliorative action may be undertaken by the embodiment of the present invention as Mark prepares to leave. Mark receives a push notification on his mobile device from embodiment to ensure that he clears the room of any content related to dollar amounts that was spoken. Further the embodiment can leverage other IOT sources such as camera feeds to point out interaction spots that may leave ‘breadcrumbs.’

Alternate embodiment can alert the user through one or many forms via IoT mesh network or IoT devices (e.g., smart speakers, conference calling device, etc.) in the room itself.

A detailed description of embodiments of the claimed structures and methods are disclosed herein; however, it is to be understood that the disclosed embodiments are merely illustrative of the claimed structures and methods that may be embodied in various forms. In addition, each of the examples given in connection with the various embodiments is intended to be illustrative, and not restrictive. Further, the figures are not necessarily to scale, some features may be exaggerated to show details of particular components. Therefore, specific structural and functional details disclosed herein are not to be interpreted as limiting, but merely as a representative basis for teaching one skilled in the art to variously employ the methods and structures of the present disclosure.

References in the specification to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments, whether or not explicitly described.

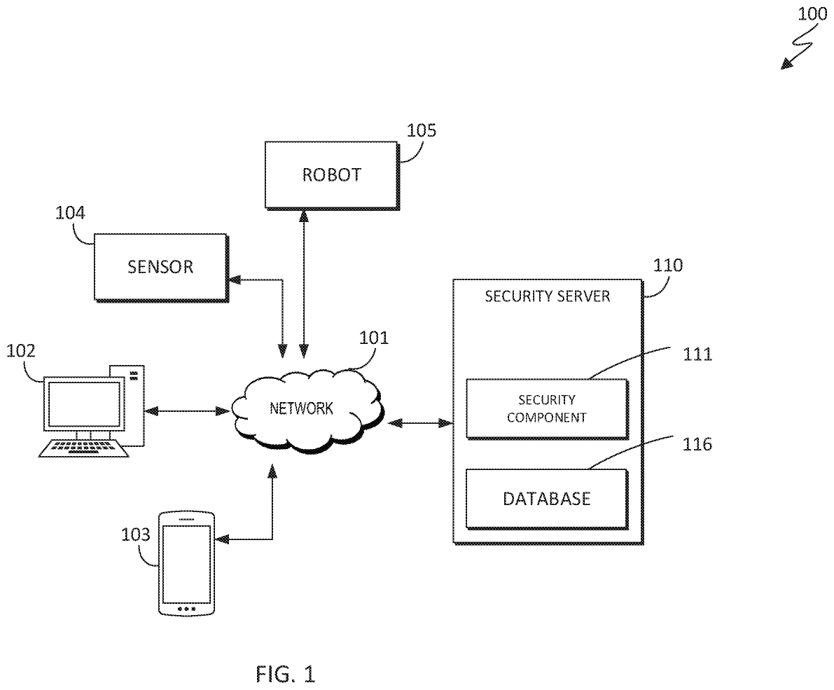

FIG. 1 is a functional block diagram illustrating a topology of a security environment, designated as 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Security environment 100 includes client computing device 102, mobile computing device 103, sensor 104, robots 105 and security server 110. All (e.g., 102, 103, 104 and 110) elements can be interconnected over network 101.

Network 101 can be, for example, a telecommunications network, a local area network (LAN), a wide area network (WAN), such as the Internet, or a combination of the three, and can include wired, wireless, or fiber optic connections. Network 101 can include one or more wired and/or wireless networks that are capable of receiving and transmitting data, voice, and/or video signals, including multimedia signals that include voice, data, and video information. In general, network 101 can be any combination of connections and protocols that can support communications between security server 110 and other computing devices (not shown) within security environment 100. It is noted that other computing devices can include, but is not limited to, client computing device 102 and any electromechanical devices capable of carrying out a series of computing instructions.

Client computing device 102 represents a network capable mobile computing device that may receive and transmit confidential data over a wireless network. Mobile computing device 102 can be a laptop computer, tablet computer, netbook computer, personal computer (PC), a personal digital assistant (PDA), a smart phone, smart watch (with GPS location) or any programmable electronic device capable of communicating with server computers (e.g., security server 110) via network 101, in accordance with an embodiment of the present invention.

Mobile computing device 103 represents a network capable mobile computing device that may receive and transmit confidential data over a wireless network. Mobile computing device 103 can be a laptop computer, tablet computer, netbook computer, personal computer (PC), a personal digital assistant (PDA), a smart phone, smart watch (with GPS location) or any programmable electronic device capable of communicating with server computers (e.g., security server 110) via network 101, in accordance with an embodiment of the present invention.

Sensor 104 represents devices that are capable of detecting objects (e.g., humans, desks, papers, tables, chairs, etc.). Sensor 104 can be IoT (Internet of Things) devices such as cameras, proximity sensor, microphone, etc.

Robot 105 is a machine that is capable of carrying out a series of actions automatically. Robot 105 can be an autonomous machine or can be controlled by a human operator. Robot 105 can be equipped with various sensors (e.g., camera, radar, proximity, etc.) which can be used for navigation and/or collection information from the surrounding environment. Robot 105 can be equipped with a mechanism for grasping/holding physical objects (i.e., robotic arm attachment) or any apparatus built to interact with the physical world. For example, robot 105 can be a cleaning robot with an apparatus for picking up objects (e.g., dirt, debris, etc.) or a security robot/drone (i.e., police/law enforcement) with an arm for opening doors, picking up items, defusing explosives, etc.

Security server 110 can be a standalone computing device, a management server, a web server, a mobile computing device, or any other electronic device or computing system capable of receiving, sending, and processing data. In other embodiments, security server 110 can represent a server computing system utilizing multiple computers as a server system, such as in a cloud computing environment. In another embodiment, security server 110 can be a laptop computer, a tablet computer, a netbook computer, a personal computer (PC), a desktop computer, a personal digital assistant (PDA), a smart phone, or any other programmable electronic device capable of communicating other computing devices (not shown) within 100 via network 101. In another embodiment, security server 110 represents a computing system utilizing clustered computers and components (e.g., database server computers, application server computers, etc.) that act as a single pool of seamless resources when accessed within security environment 100.

Security server 110 includes security component 111 and database 116.

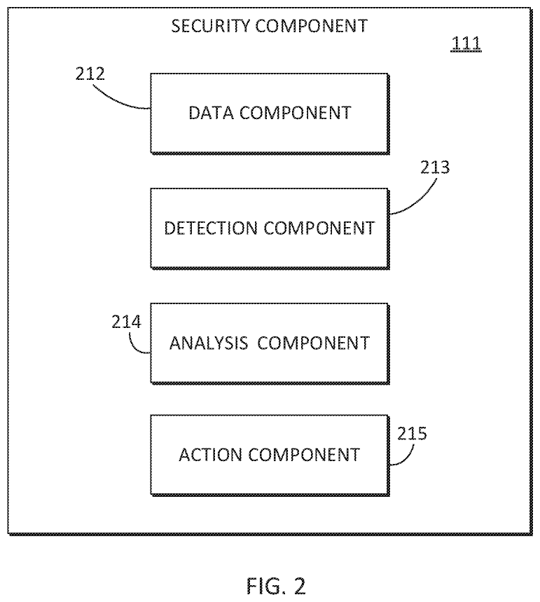

Security component 111 enables the present invention to secure scheduled meetings in a shared workspace and take ameliorating action to mitigate the risk of accidental exposure of sensitive information during and at the end of the meeting. It is noted that cognitive computing can be utilized throughout the entire process (i.e., beginning to end) or part of the process/component of the system. Security component 111 will be described in greater details in regard to FIG. 2.

Database 116 is a repository for data used by security component 111. Database 116 can be implemented with any type of storage device capable of storing data and configuration files that can be accessed and utilized by security server 110, such as a database server, a hard disk drive, or a flash memory. Database 116 uses one or more of a plurality of techniques known in the art to store a plurality of information. In the depicted embodiment, database 116 resides on security server 110. In another embodiment, database 116 may reside elsewhere within security environment 100, provided that security component 111 has access to database 116. Database 116 may store information associated with, but is not limited to, corpus knowledge of tables of risk scores, risk score thresholds, roles of employees, scheduling calendar of shared workspace, context of sensitive materials, etc.

FIG. 2 is a functional block diagram illustrating security component 111 in accordance with an embodiment of the present invention. In the depicted embodiment, security component 111 includes data component 212, detection component 213, analysis component 214 and action component 215.

As is further described herein below, data component 212, of the present invention provides the capability of, by leveraging machine learning, gathering and discerning historical information (e.g., user's role, data used by the user, relationship between user and clients, available sensors/IoT devices, sensitivity threshold, etc.) associated with the users occupying the shared workspace. Information regarding user's role can include, but it is not limited to, security level of the user, security override and confidentiality exposure of content. Data used by the user can include, but it is not limited to, NLU (natural language understanding) of emails, NLU of messages and contextual processing of information in the files and activities. For example, an email header stating “CONFIDENTIAL” can be recognized by machine learning as information that should be restricted. Other examples can include presence of locked documents and check in/check out status of those documents as an indicator to the machine learning (i.e., contextual processing) that the files are restrictive. Information related to a relationship between user and clients can be denoted as i) type/kind of information being shared where the content classification of data shared to non-owned emails and ii) type/kind of information is open versus information that is monitored/restricted. Data related to available sensors/IoT devices can be useful for data component 212 to determine what devices are available in the shared user space. Essentially, data component 213 determines available historical information as the user enters the shared workspace.

For illustrative purpose, a use case scenario will be described further. UserA and UserB both work for CompanyA scheduled a meeting in RoomA. UserA works as a compensation manager in the HR (Human Resources) department of CompanyA. UserB is an employment attorney for CompanyA. UserA and UserB is meeting in RoomA to discuss employee salary/compensation structure based on job bands. UserA has emailed UserB with an excel spreadsheet with employee's name and salary before the meeting. However, UserB did not have time to read and decided to print out the spreadsheet to bring to the meeting. Data component 212 can determine that the meeting scheduled in RoomA may contain sensitive/restrictive subject based on i) the email subject between UserA and UserB, and ii) attachment with “CONFIDENTIAL” watermark.

As is further described herein below, detection component 213, of the present invention provides the capability of discerning activities of users and presence of artifacts in a shared workspace by leveraging machine learning. Detection component 213 can use sensor 104 (e.g., IoT cameras, IoT microphone, etc.) to determine the presence of the users (e.g., number of users, role of users, etc.) in the shared workspace and determine the activity that is occurring in the shared workspace. For example, detection component 213 recognizes UserA and UserB in RoomA. Furthermore, detection component 213 can recognize printed paper (i.e., physical artifact) on the table in RoomA with the word, “CONFIDENTIAL” (i.e., spreadsheet printed out by UserB). It is noted that detection component 213 continuously monitors the shared workspace during the meeting and not just when users enter the room. Thus, if the topic being discussed switches from employee parking to employee compensation then detection component 213 can relay that audio data for analysis component 214 to make a determination of a new risk rating/score.

As is further described herein below, analysis component 214, of the present invention provides the capability of determining what information (e.g., voice discussion, physical artifacts, etc.) are considered restrictive by assigning a numerical score. It is noted that there are several risk thresholds and risk scores that can be calculated and assigned by analysis component 214. For example, risk scores can include, but it is not limited to, activity risk score (ARS), role risk score (RRS) and context risk score (CRS). ARS can be defined as risk scores associated with activities within the shared workspace (see Table 1). RRS can be defined as risk score associated with a role of users (see Table 3). And CRS can be defined as risk score associated with the data being discussed in the shared workspace (see Table 2). Thus, there are corresponding risk thresholds to ARS, RRS and CRS. For example, a total risk threshold (TRT) is a summation of the following thresholds, activity risk threshold (ART), risk role threshold (RRT) and context risk threshold (CRT). All the risk threshold are user-selectable and adjustable. It is noted that a numerical scale can be determined and agreed upon before system initialization. Table 1 through Table 3 contains a scale range of 1 to 10 (i.e., 10 designated as the most sensitive/restrictive and 1 designated as the least). It is noted that security component 111 can rely on other type of risk scoring that does not rely on tables. For examples, security component 111, over time via machine learning, can make decision without relying on scoring tables and use internal model and/or experience to make that risk determination.

TABLE 1

| | Overall Score |
|---|---|
| Meeting Activities | (1-10) |
| Compensation | 9 |
| Employee Parking | 1 |
| Business Strategy | 10 |

Analysis component 214, by leveraging machine learning, can learn about historical information (through data component 212) of users and the proposed activity in the shared workspace. Referring to the prior use case with UserA and UserB. UserA schedules a meeting in RoomA through the company's online room scheduling system under the title, “COMPENSATION DISCUSSION.” Security component 111 can begin to gather data after RoomA is booked with that title. Security component 111 can determine the number of users and the roles of users attending in RoomA. Security component 111 identified UserA as a HR Compensation manager and UserB as an Employment Attorney. Thus, security component 111 can determine that the activity in RoomA may contain sensitive and/or restrictive matter and can assign an ARS rating of 9 (based on Table 1). The ART is set at 7. Thus, analysis component 214 has determined the activity in Room A (i.e., ARS 9>ART 7) is deem sensitive and poses a risk.

Furthermore, analysis component 214 can be trained to via NLU or any machine learning method to understand the context of data discussed during the activities to determine the sensitivity and risk and assigned a CRS. It is noted that specific activities mentioned in Table 1 can be expanded further to include sub-activity factors, such as, words and phrases and included data being discussed (see Table 2). Furthermore, other context can include where content is, who content has been sent to, content flags (i.e., “don't share this”), etc.

TABLE 2

| | Overall Score |
|---|---|
| Compensation Data | (1-10) |
| Employee Full Name and Preferred Name | 2 |
| Employee Salary (tied to a name or Employee ID) | 10 |
| “Confidential” verbiage (email, spoken dialogue, etc.) | 10 |
| Address of Employee | 4 |

Thus, the context (i.e., discussion regarding compensation) in RoomA can be rated at a CRR of 10 (per Table 2) due to the appearance of “CONFIDENTIAL” verbiage printed on the spreadsheet. It is noted that CRR score can be the mathematical average of scores related to the context since there can be more items discussed or shared.

In another embodiment, analysis component 214 can determine which users in the shared workspace is authorized to be exposed to the restrictive/sensitive information. Analysis component 214 can retrieve the employee profile of the users to ascertain a user role score (see Table 3). For example, userA is a compensation manager and userB is an employment attorney and has an individual RRS of 10 and 9, respectively but a combined RRS of 7 (i.e., average of 10 and 9). Thus, both userA and UserB's role are deem sensitive in nature based on the RRT set at 7. It is noted that combined CRR score can be the mathematical average of scores related to the roles since there are typically more than one user in a meeting.

TABLE 3

| | Overall Score |
|---|---|
| Employee Role | (1-10) |
| Attorney Staff | 9 |
| General Administrative Staff | 5 |
| Executive Administrative Staff | 7 |
| Facilities Staff | 1 |
| Vice President level and above | 9 |
| Compensation Staff | 10 |
| Graphics Stuff | 2 |

It is possible that all risk scores can be used to determine the overall risk level. For example, referring to the previous user case scenario, userA and userB (i.e., an average RRS of 9.5 based on the RRS of 10 and 9) meeting in roomA (i.e., ARS 10) to discuss compensation and having a printed spreadsheet with the word “CONFIDENTIAL” (i.e., CRS 10) would yield a total score of 29.5. The thresholds, TRT, RRT and CRT are set at 7 per threshold with a combine threshold of 21. Thus, analysis component 214 has determined that the overall activity (including role of the users, context of data, etc.) in RoomA is sensitive in nature.

It is further noted that analysis component 214, through machine learning, can use just one risk score to compare against a threshold instead of relying on all three risk score against all three risk thresholds. For example, using a new use case scenario, userC, a VP of Human Resources is meeting with userD, graphics artist. Both users are having an informal meeting to discuss the upcoming company picnic in roomB. Analysis component 214 has assigned an RRS for userC and userD as 5.5 (i.e. average of 9 and 2). So far, the meeting does not trigger any risk (i.e., sensitive subject). However, UserC, left an executive meeting with the VP of Sales and was in a rush to meet userD to discuss the logo design for the company picnic. UserC was carrying sales figure from the previous quarter and was marked as “CONFIDENTIAL.” During the meeting in roomB, the sales figure paper slipped and accidently fell onto the floor by the desk. Analysis component 214, through detection component 213, notices a “new” physical artifact that “appeared” after the meeting has commenced in roomB. Detection component 213 was able to decipher the word, “CONFIDENTIAL” on the sales figure. Analysis component 214 has now assigned a CRS of 10 to the meeting.

Furthermore, RRT can be used as dual threshold to determine if roles of users is authorized to listen to sensitive information in addition to determining if the roles of the user area considered sensitive. For example, userA and userB was assigned an RRS of 10 and 9, respectively (per Table 3). Both userA and userB are qualified to discuss payroll and compensation due to their RRS as meeting an RRT (i.e., now being used as threshold to determine if roles of users are authorized). However, userD (i.e., Graphics artist) wanders into roomA accidently thinking that was the room he was scheduled to meet userC (i.e., VP of Sales). UserD (per Table 3) is assigned an RRS of 2 and RRT is set to 7. Analysis component 214 has determine that the new user (i.e., userD) in the room (i.e, roomA) is not authorized to hear sensitive topic based on user's RRS of 2 as not meeting the threshold of 7 (i.e., RRT).

As is further described herein below, action component 215, of the present invention provides the capability of, by leveraging machine learning, recommending and taking action (i.e., generating one or more action plans) to ameliorate/alleviate/mitigate the risk of i) discussion in the workspace being overheard, ii) leaving physical artifacts in the room after the meeting has concluded and iii) monitor the recording status of all electronic devices in the shared workspace. Regarding, “discussion in the workspace being overheard,” action component 215 can i) notify users to keep the voices from being too loud, ii) turn on or turn up the volume of white noise (if available) equipment within the shared workspace and iii) obstructing/obscuring physical artifacts (including presentation being shown on the screen) from being seen/exposed to the un-authorized individual. Additionally, action component 215 can also alert (e.g., text alerts, email or announcing over an IoT device in the shared workspace) users (either authorized users or unauthorized users in the shared workspace) to cease discussion of the sensitive topic. Regarding “leaving physical artifacts in the room after the meeting has concluded,” action component 215 can notify users (e.g., text alert, emails, announcing via IoT device, etc.) as they're exiting the shared workspace to gather all physical artifacts (i.e., salary spreadsheet from RoomA). Regarding “monitoring the recording status of all electronic devices in the shared workspace”, action component 215 can (i.e. installed as part of an app on mobile devices or on PCs) disable microphones on recording any devices in the shared workspace during the meeting/discussion so that recording does not damage the reputation of the company.

In other embodiment action component 215, can instruct robots to remove physical artifacts left in the shared workspace. For example, action component 215 can instructing a cleaning robot to remove the salary spreadsheet from RoomA after UserA and UserB left without remembering (or inadvertently ignoring the text message) to remove the spreadsheet.

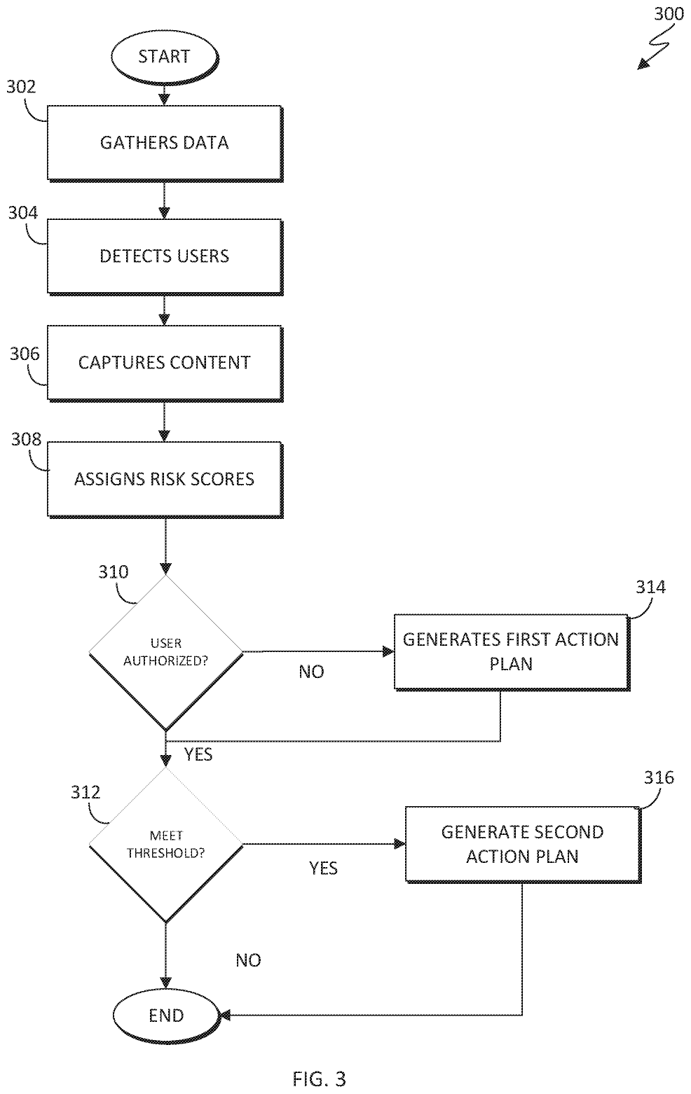

FIG. 3 is a flowchart illustrating the operation of a security environment 100, designated as 300, in accordance with an embodiment of the present invention.

Security component 111 gathers data (step 302). In an embodiment, security component 111, through data component 212, gathers data related to the scheduled meeting. XYZ. Data can be gathered from sensor 104 and/or electronic interaction (e.g., user's role, data used by the user, relationship between user and clients, sensitivity threshold, etc.) associated with one or more users as soon as the user enters the shared workspace. For example, as soon as userA and userB enters roomA, data component 212, begins to gather “historical” data (e.g., topic of discussion is “Compensation” based on the emails subject, etc.) related to both users.

In another embodiment, security component 111 can begin to gather historical data associated with the users scheduled and proposed topics to be discussed before users enter the shared workspace. For example, security component 111 was notified that roomA was being scheduled by userA and userB by a company meeting calendar system. Security component 111 can being to monitor and gather any historical data (e.g., email conversation) between userA and userB before userA and userB has step into roomA.

Security component 111 detects users (step 304). In an embodiment, security component 111, through detection component 213, detects users as they enter the shared workspace. For example, security component 111 is able to discern that userA and userB have entered roomA through an IoT camera (i.e., sensor 104).

Security component 111 capture content (step 306). In an embodiment, security component 111, through detection component 213, is able to capture audio and video content occurring in the shared workspace. For example, security component 111, can listen to the audio conversation within roomA and can detect physical artifacts (i.e., printed salary spreadsheet by userB) in the room that may be construed as sensitive information.

Security component 111 assigns risks scores (step 308). In an embodiment, security component 111, through analysis component 214, can assign various scores to the entire activity. For example, security component 111 can assign an RRS for userA and userB as 10 and 9, respectively. Security component 111 can also assign a CRS of 10 for the salary spreadsheet in roomA.

Security component 111 determines if users are authorized (decision block 310). In an embodiment, security component 111, through analysis component 214, determines if the risk scores assigned to the users meet an RRT. If analysis component 214 has determined that the users are authorized (“YES” branch of decision block 310), analysis component 214 proceeds to decision block 312. For example, from the prior user case, userA and userB was assigned an RRS of 10 and 9 (per Table 3) respective. RRT is set at 7. Both userA and userB are qualified to discuss payroll and compensation due to their RRS meeting the threshold of 7 (i.e., RRT). However, if analysis component 214 has determined that the users are not authorized (“NO” branch of decision block 310), analysis component 214 proceeds to take action (step 314).

Security component 111 determines if activity exceeded the threshold (decision block 312). In an embodiment, security component 111, through analysis component 214, determines if the activity (e.g., topics discussed, artifacts, etc.) in the shard workspace exceeds the combined threshold (e.g., RRT, CRT, ART, etc.). If analysis component 214 has determined that the activity exceeded either one or more thresholds (“NO” branch of decision block 312), analysis component 214 can allow the activity to continue without any action. However, if analysis component 214 has determined that the activity exceeded either one or more thresholds (“YES” branch of decision block 312), analysis component 214 proceeds to take a second action (step 316). For example, referring to the previous user case scenario, userA and userB (i.e., an average RRS of 9.5 based on the RRS of 10 and 9) meeting in roomA (i.e., ARS 10) to discuss compensation and having a printed spreadsheet with the word “CONFIDENTIAL” (i.e., CRS 10) would yield a total score of 29.5. The thresholds, TRT, RRT and CRT are set at 7 per threshold with a combine threshold of 21. Thus, analysis component 214 has determined that the overall activity (including role of the users, context of data, etc.) in RoomA is sensitive in nature.

Security component 111 generates first action plan (step 314). In an embodiment, security component 111, through action component 215, generates a first action plan based on unauthorized users in the shared workspace. A first action plan can include, but it is not limited to, alerting (e.g., mobile alert, email, etc.) the current user in the shared workspace of the intrusion by an unauthorized user, announcing the intrusion over IoT devices and alerting (e.g., mobile alert, email, etc.) the unauthorized user to leave the meeting workspace. For example, security component 111 has determined that userD (i.e., graphic artist with an RRS of 2) has accidentally wander into roomA with userA and userB. Security component 111 has determined that userD is not authorized to the content of the meeting in roomA. Thus, security component 111 can notify userA and userB (via text messaging or email) that userD is not authorized and should stop discussing the sensitive topic. Security component 111 could also announce over the IoT device such as smart speaker (if the room is equipped) to let userA and userB to cease discussing until the userD is no longer in the room.

Security component 111 generates second action plan (step 316). In an embodiment, security component 111, through action component 215, generates a second action plan to ameliorate the risk of any sensitive physical artifacts left behind after the end of the meeting. For example, referring to the use case of userA and userB's meeting. Nearing the conclusion of the meeting in roomA, security component 111 can alert userA and userB to take any physical artifacts with them before the conclusion of the meeting.

In an alternative embodiment, security component 111 can also instruct robots to remove any remaining sensitive artifacts from the room in case users forget and/or ignore the reminder to perform the action. For example, security component 111 can send a cleaning robot to roomA to sweep and remove any salary spreadsheets left on the table.

The present invention may be a system, a method, and/or a computer program product. The computer program product may include a computer readable storage medium (or media) having computer readable program instructions thereon for causing a processor to carry out aspects of the present invention.

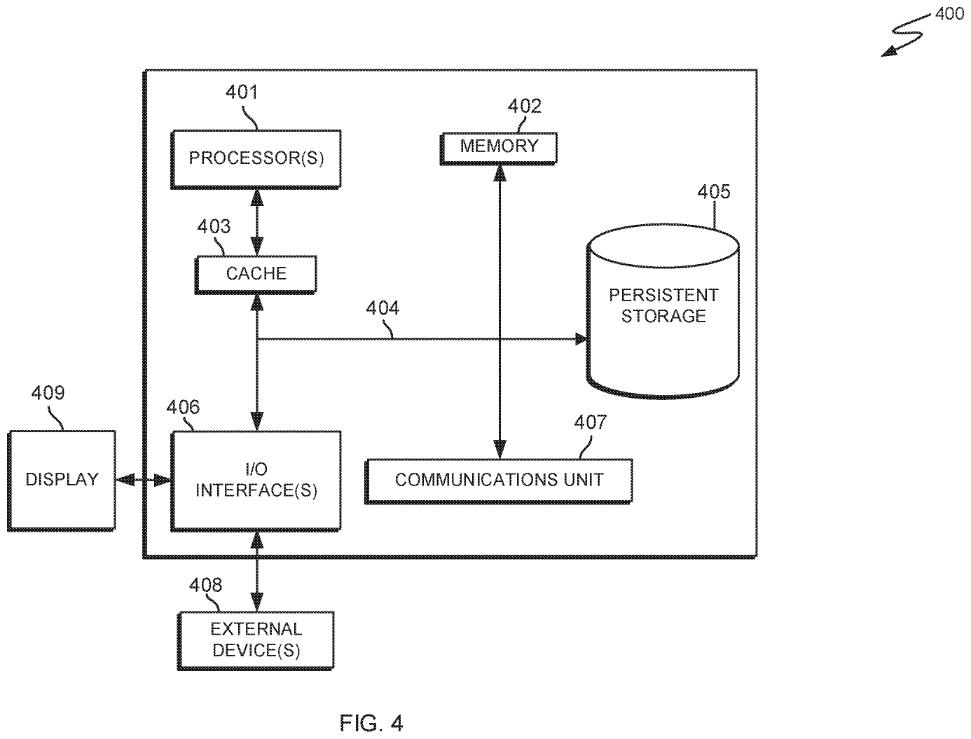

FIG. 4 depicts a block diagram, designated as 400, of components of ad intelligence component 111 application, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

FIG. 4 includes processor(s) 401, cache 403, memory 402, persistent storage 405, communications unit 407, input/output (I/O) interface(s) 406, and communications fabric 404. Communications fabric 404 provides communications between cache 403, memory 402, persistent storage 405, communications unit 407, and input/output (I/O) interface(s) 406. Communications fabric 404 can be implemented with any architecture designed for passing data and/or control information between processors (such as microprocessors, communications and network processors, etc.), system memory, peripheral devices, and any other hardware components within a system. For example, communications fabric 404 can be implemented with one or more buses or a crossbar switch.

Memory 402 and persistent storage 405 are computer readable storage media. In this embodiment, memory 402 includes random access memory (RAM). In general, memory 402 can include any suitable volatile or non-volatile computer readable storage media. Cache 403 is a fast memory that enhances the performance of processor(s) 401 by holding recently accessed data, and data near recently accessed data, from memory 402.

Program instructions and data (e.g., software and data x10) used to practice embodiments of the present invention may be stored in persistent storage 405 and in memory 402 for execution by one or more of the respective processor(s) 401 via cache 403. In an embodiment, persistent storage 405 includes a magnetic hard disk drive. Alternatively, or in addition to a magnetic hard disk drive, persistent storage 405 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 405 may also be removable. For example, a removable hard drive may be used for persistent storage 405. Other examples include optical and magnetic disks, thumb drives, and smart cards that are inserted into a drive for transfer onto another computer readable storage medium that is also part of persistent storage 405. Ad intelligence component 111 can be stored in persistent storage 405 for access and/or execution by one or more of the respective processor(s) 401 via cache 403.

Communications unit 407, in these examples, provides for communications with other data processing systems or devices. In these examples, communications unit 407 includes one or more network interface cards. Communications unit 407 may provide communications through the use of either or both physical and wireless communications links. Program instructions and data (e.g., Ad intelligence component 111) used to practice embodiments of the present invention may be downloaded to persistent storage 405 through communications unit 407.

I/O interface(s) 406 allows for input and output of data with other devices that may be connected to each computer system. For example, I/O interface(s) 406 may provide a connection to external device(s) 408, such as a keyboard, a keypad, a touch screen, and/or some other suitable input device. External device(s) 408 can also include portable computer readable storage media, such as, for example, thumb drives, portable optical or magnetic disks, and memory cards. Program instructions and data (e.g., Ad intelligence component 111) used to practice embodiments of the present invention can be stored on such portable computer readable storage media and can be loaded onto persistent storage 405 via I/O interface(s) 406. I/O interface(s) 406 also connect to display 409.

Display 409 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for securing a shared physical workspace from leaking sensitive subject matter, further comprising:
gathering, by machine learning, data associated with a meeting scheduled for a shared physical workspace;
detecting one or more users entering the shared physical workspace for the schedule meeting;
capturing, by machine learning, content of the meeting in the shared workspace;
assigning, by machine learning, one or more risk score based on the captured content;
determining whether the one or more users are authorized to be exposed to the captured content based on the one or more risk score;
responsive to determining that the one or more users are not authorized, generating and executing a first action plan;
determining, by machine learning, whether the captured content exceed one or more risk threshold; and
responsive to determining that the captured content exceeds the one or more risk threshold, generating and executing a second action plan, by machine learning.

2. The computer-implemented method of claim 1, wherein gathering data further comprises of gathering historical data, using machine learning, wherein the historical data comprises of context of the meeting agenda, identity and electronic activity between participants, and pre-meeting interactions.

3. The computer-implemented method of claim 1, wherein capturing content comprises of capturing the content using audio, visual, IoT device and sensor data.

4. The computer-implemented method of claim 1, wherein determining whether the one or more users are authorized further comprises:
assigning an RRS (role risk score) to the one or more users based on one or more roles of the one or more users;
determining if the RRS is greater than an RRT (role risk threshold); and
responsive to determining that the RRS is greater than the RRT, granting authority to the one or more user.

5. The computer-implemented method of claim 1, wherein determine whether the captured content exceed the one or more risk threshold, further comprises:
assigning a CRS (context risk score) to the one or more users based on the captured content;
assigning an ARS (activity risk score) to the one or more users based on the captured content;
combining the ARS and the CRS into a first combined risk score;
combining an ART (activity risk threshold) and CRT (context risk threshold) into a first combined risk threshold; and
determining if the first combined risk score greater than the first combined risk threshold.

6. The computer-implemented method of claim 1, wherein the first action plan further comprises:
notifying the user to alleviate the risk, wherein alleviating the risk comprises of, ceasing discussion of sensitive material, removing meeting participants not authorized to discuss the sensitive material, and obscuring the sensitive material from view of meeting participants.

7. The computer-implemented method of claim 1, wherein the second action plan further comprises:
notifying the users to remove a sensitive material from the shared physical workspace at the conclusion of the meeting; and
instructing robots to remove the sensitive material from the shared physical workspace at the conclusion of the meeting.

8. A computer program product for securing a shared physical workspace from leaking sensitive subject matter, the computer program product comprising one or more computer readable storage media and program instructions stored on the one or more computer readable storage media, the program instructions comprising:
program instructions to gather, by machine learning, data associated with a meeting scheduled for a shared physical workspace;
program instructions to detect one or more users entering the shared physical workspace for the schedule meeting;
program instructions to capture, by machine learning, content of the meeting in the shared workspace;
program instructions to assign, by machine learning, one or more risk score based on the captured content;
program instructions to determine whether the one or more users are authorized to be exposed to the captured content based on the one or more risk score;
responsive to determine that the one or more users are not authorized, program instructions to generate and executing a first action plan;
program instructions to determine, by machine learning, whether the captured content exceed one or more risk threshold; and
responsive to determine that the captured content exceeds the one or more risk threshold, program instructions to generate and executing a second action plan, by machine learning.

9. The computer program product of claim 8, wherein gathering data further comprises of gathering historical data, using machine learning, wherein the historical data comprises of context of the meeting agenda, identity and electronic activity between participants, and pre-meeting interactions.

10. The computer program product of claim 8, wherein capturing content comprises of capturing the content using audio, visual, IoT device and sensor data.

11. The computer program product of claim 8, wherein determining whether the one or more users are authorized further comprises:
program instructions to assign an RRS (role risk score) to the one or more users based on one or more roles of the one or more users;
program instructions to determine if the RRS is greater than an RRT (role risk threshold); and
responsive to determine that the RRS is greater than the RRT, program instructions to granting authority to the one or more user.

12. The computer program product of claim 8, wherein determine whether the captured content exceed the one or more risk threshold, further comprises:
program instructions to assign a CRS (context risk score) to the one or more users based on the captured content;
program instructions to assign an ARS (activity risk score) to the one or more users based on the captured content;
program instructions to combine the ARS and the CRS into a first combined risk score;
program instructions to combine an ART (activity risk threshold) and CRT (context risk threshold) into a first combined risk threshold; and
program instructions to determine if the first combined risk score greater than the first combined risk threshold.

13. The computer program product of claim 8, wherein the first action plan further comprises:
program instructions to notify the user to alleviate the risk, wherein alleviating the risk comprises of, ceasing discussion of sensitive material, removing meeting participants not authorized to discuss the sensitive material, and obscuring the sensitive material from view of meeting participants.

14. The computer program product of claim 8, wherein the second action plan further comprises:
program instructions to notify the users to remove a sensitive material from the shared physical workspace at the conclusion of the meeting; and
program instructions to instruct robots to remove the sensitive material from the shared physical workspace at the conclusion of the meeting.

15. A computer system for securing a shared physical workspace from leaking sensitive subject matter, the computer system comprising:
one or more computer processors;
one or more computer readable storage media;
program instructions stored on the one or more computer readable storage media for execution by at least one of the one or more computer processors, the program instructions comprising:
program instructions to gather, by machine learning, data associated with a meeting scheduled for a shared physical workspace;
program instructions to detect one or more users entering the shared physical workspace for the schedule meeting;
program instructions to capture, by machine learning, content of the meeting in the shared workspace;
program instructions to assign, by machine learning, one or more risk score based on the captured content;
program instructions to determine whether the one or more users are authorized to be exposed to the captured content based on the one or more risk score;
responsive to determine that the one or more users are not authorized, program instructions to generate and executing a first action plan;
program instructions to determine, by machine learning, whether the captured content exceed one or more risk threshold; and
responsive to determine that the captured content exceeds the one or more risk threshold, program instructions to generate and executing a second action plan, by machine learning.

16. The computer system of claim 15, wherein gathering data further comprises of gathering historical data, using machine learning, wherein the historical data comprises of context of the meeting agenda, identity and electronic activity between participants, and pre-meeting interactions.

17. The computer system of claim 15, wherein capturing content comprises of capturing the content using audio, visual, IoT device and sensor data.

18. The computer system of claim 15, wherein determining whether the one or more users are authorized further comprises:
program instructions to assign an RRS (role risk score) to the one or more users based on one or more roles of the one or more users;
program instructions to determine if the RRS is greater than an RRT (role risk threshold); and
responsive to determine that the RRS is greater than the RRT, program instructions to granting authority to the one or more user.

19. The computer system of claim 15, wherein determine whether the captured content exceed the one or more risk threshold, further comprises:
program instructions to assign a CRS (context risk score) to the one or more users based on the captured content;
program instructions to assign an ARS (activity risk score) to the one or more users based on the captured content;
program instructions to combine the ARS and the CRS into a first combined risk score;
program instructions to combine an ART (activity risk threshold) and CRT (context risk threshold) into a first combined risk threshold; and
program instructions to determine if the first combined risk score greater than the first combined risk threshold.

20. The computer system of claim 15, wherein the first action plan further comprises:
program instructions to notify the user to alleviate the risk, wherein alleviating the risk comprises of, ceasing discussion of sensitive material, removing meeting participants not authorized to discuss the sensitive material, and obscuring the sensitive material from view of meeting participants.
